(19) United States
(12) Patent Application Publication
(10) Pub. No.: US 2005/0216688 A1
(43) Pub. Date: Sep. 29, 2005

(54) Copy control apparatus and method

(75) Inventor: Futoshi Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/979,182

(22) Filed: Nov. 3, 2004

(30) Foreign Application Priority Data
Mar. 23, 2004 (JP) 2004-084423

(51) Int. Cl. G06F 12/16

(52) U.S. Cl. 711/165; 711/162

(57) ABSTRACT

A copy control apparatus implements initial copies which copy data of the storage apparatus of a copy source to the storage apparatus of a copy destination, and, in the control of keeping the data of the copy source and that of copy destination equivalent, decreases the multiplicity in accordance with the increase of the number of write requests in which the updating of the data of the copy source is not yet reflected to the data of the copy destination, and implements a plurality of initial copies within the decreased range of multiplicity.

### BACKGROUND OF THE INVENTION

1. Field of the Invention

The present invention relates to an apparatus and method for carrying out the control of copying data between a storage apparatus and another storage apparatus without the intermediation of a host device in a storage system having a plurality of storage devices.

2. Description of the Related Art

The storage system comprises one or more storage apparatuses, and the storage apparatus comprises a storage device such as a magnetic disk device and a storage control device controlling the transfer of data between one or more host devices and the storage device. The host device is, for example, an information processing device (computer) which reads or writes data in the storage device, and the data stored in the storage device is sometimes shared by a plurality of host devices.

In such a storage system, there are two conventional methods for backing up data of a magnetic disk device, as follows.

(1) Method of copying data with the intermediation of a host device.

In this method, a host device for mainstay business 11 reads data which is the object of backup from a magnetic disk device 15 in a storage apparatus 13, and transfers the data to a backup host device 12 via a communication network, as shown in FIG. 1A. The backup host device 12 writes the received data to a backup magnetic device 16 in a storage apparatus 14. When the storage apparatus 14 is directly connected to the host device for mainstay business 11, the host device for mainstay business 11 writes the read data to the magnetic disk device 16.

(2) Method of copying data without the intermediation of a host device (Refer to, for example, patent documents 1, 2, 3, 4 and 5 described below.)

In this method, the host device for mainstay business 11 instructs the storage apparatus 13 to copy data, as shown in FIG. 1B. Then, the storage apparatus 13 takes out the data which is the object of backup from the magnetic disk device 15 and transfers said data to the storage apparatus 14 via the communication network. The storage apparatus 14 writes the received data to the backup magnetic disk device.

The function of REC (Remote Equivalent Copy) is well known as an example of the above method (2), and this function is largely classified into the following two operations.
1. To copy data of a designated logic unit. A logic unit corresponds to a volume in a mainframe system, and corresponds to a slice or a partition in an open system.
2. To keep the logic units of copy source and copy destination equivalent after copying is finished. In other words, the updating of data in the logic unit of copy source is reflected to the logic unit of copy destination, and the data of both logic units is kept equivalent.

FIG. 1C shows a series of operations in this REC. First, a pair of logic units of copy source (Src.) and copy destination (Dest.) are designated by the copy instruction from the host device in time T1, and a pair of logic units are established in time T2, and then copying starts. While a pair of logic units is designated, writing to the logic unit of copy destination (write access) is prohibited.

After copying finishes in Time T4, the updating of (writing to) the copy source in Time T5 in which data equivalence is maintained is reflected to the copy destination, and the updating of the copy source in time T3 in which copying is under way is also reflected to the copy destination as needed. Then, the logic units of copy source and copy destination are handled as an independent logic unit respectively by the instruction of dissolving a pair of logic units received from the host device in time T6, and writing to the copy destination becomes possible.

Thus, there are both the processing of copying the whole data of a logic unit (hereinafter referred to as “initial copy”) and the processing of copying data according to the updating of data from a host device (hereinafter referred to as “write extension copy”) in the copy processing.

When the storage apparatus of copy destination and that of copy source are close to each other, the delay occurring along with data transfer can be neglected, and no problem arises therefrom. However, when the distance between the two storage apparatuses is long and a remote copy has to be implemented, the delay occurring along with data transfer greatly affects the copy performance. In the case of only an initial copy, the transfer delay appears only as the problem of a remote-copy performance. In the case of a write extension copy, however, the transfer delay appears as the write performance of the storage apparatus itself.

In order to solve this problem, an asynchronous transfer method is provided in which when writing to the logic unit of copy source finishes, the completion of the writing is notified to the host device, and after then, copy processing is implemented to the copy destination.

However, the perfect equivalence of data between the copy source and the copy destination is required in most cases for the disaster recovery, etc. of a database system, so there is no other alternative but to employ a synchronous transfer method in which after writing to the copy destination finishes, the response is returned to the host device. In this case, the performance of the storage apparatus depends largely on the performance of data transfer between a storage apparatus and another storage apparatus.

The problem here is that both an initial copy and a write extension copy must be implemented within a limited transfer capability. While the initial copy is in operation, the resources of the storage apparatus are used for the processing, so that the resources which can be used for the write extension copy decrease, and as a result, the write performance of the storage apparatus lowers.

In a conventional method, “copy interval time” calculated from the number of copy instructions to be simultaneously implemented is set in advance, and an initial copy is operated in the time interval which does not affect the write extension copy in order to avoid this particular problem.

FIG. 1D shows control data used for such an initial copy. In this example, for the instruction of copying n (number), initial copy control blocks of n B1 to Bn are prepared in the storage apparatus as the control information which designates the data of copy source, and copy interval time T is set. Included in each initial copy control block are the copy start position of the data of copy source, copy finish position of the data of copy source, and bit map for managing a copied region, as shown in FIG. 1E, and copy interval time T is calculated in advance from the estimated number of copy instructions.

FIG. 1F is a flowchart of the initial copy which the storage apparatus implements. The storage apparatus implements the copy of the data of L byte from initial copy control blocks B1 to Bn (Step 21), and checks whether all the initial copies have finished with reference to the initial copy control blocks B1 to Bn (Step 22). Unless all the initial copies have finished, the storage apparatus checks whether interval time T has passed (Step 23) and waits for the lapse of interval time T. After the interval time T has passed, the storage apparatus repeats the processing of Step 21 and onward, and finishes the processing if all the initial copies finish in Step 22.

According to this control, after the copy of the data of L byte is implemented, data transfer is stopped for a period until interval time T passes, so it becomes possible to use the resources of the storage apparatus for the write extension copy.

Patent document 6 relates to the method in which when data stored in a storage device is rearranged, the load of a host device and a channel is alleviated by data transfer.

Patent document 7 relates to the method in which when a plurality of updating access occurs to copy data in a system which copies data from a low-speed storage device to a high-speed storage device and speeds up data access, the copy data and original data are made to agree without keeping the updating access following the preceding updating access waiting.
Patent document 1: Kokai (Jpn. unexamined patent publication) No. 2003-099309
Patent document 2: Kokai (Jpn. unexamined patent publication) No. 2002-189570
Patent document 3: Description (US2003/0014534 A1) of US unexamined patent publication No. 2003/0014534
Patent document 4: Description (EP1217523 A1) of European unexamined patent publication No. 1217523
Patent document 5: Description (US2002/0078296A1) of US unexamined patent publication No. 2002/0078296
Patent document 6: Kokai ((Jpn. unexamined patent publication) No. 2002-259172
Patent document 6: Kokai ((Jpn. unexamined patent publication) No. 3-111952

According to the initial copy of the conventional storage apparatus described above, there is a problem in that since the copy process is stopped during the set interval time T even in the state in which there is still enough room left in the data transfer capability, the performance of an initial copy lowers. The write performance is guaranteed in the time zone during which no initial copy is implemented, but when interval time T is set to a long interval time, no initial copy is implemented even if there is no write extension copy, and the response to the copy instruction becomes worse.

### SUMMARY OF THE INVENTION

The purpose of the present invention is to provide a copy control apparatus and method which secures both the write performance and the initial copy performance using the transfer capability of a storage apparatus effectively when writing to the data of copy source from a host device is implemented by a synchronous transfer method in a remote copy which maintains data equivalence between a storage apparatus and another storage apparatus.

The first and second copy control apparatuses comprise a storage device, a receiving device, a processing device, and a transmission device, and implement the initial copy which copies the data of a storage apparatus of a copy source in a storage apparatus of a copy destination and carries out the control of keeping the data of copy source and the data of copy destination equivalent.

The storage device stores the information of multiplicity which indicates the number of initial copies which can be simultaneously implemented, and the receiving device receives write requests for the data of copy source.

In the first copy control apparatus of the present invention, the processing device implements a plurality of initial copies within a range of multiplicity when the number of write requests in which the updating of the data of the copy source is not yet reflected to the data of copy destination, and the processing device changes the multiplicity to a smaller value when the number of write requests is larger than a given value, and implements a plurality of initial copies within the changed range of multiplicity. The transmission device transfers the data of copy source using the storage apparatus of copy destination as the transfer destination when the initial copies are implemented.

In the second copy control apparatus of the present invention, the processing device decreases the multiplicity in accordance with the increase of the write requests in which the updating of the data of copy source is not yet reflected to the data of copy destination, and implements a plurality of initial copies within the decreased range of multiplicity. The transmission device transfers the data of the copy source using the storage apparatus of copy destination as the transfer destination when the initial copies are implemented.

### BRIEF DESCRIPTION OF THE DRAWINGS

FIG. 1A shows the copy of data with the intermediation of a host device.

FIG. 1B shows the copy of data without the aid of a host device.

FIG. 1C shows REC (Remote Equivalent Copy).

FIG. 1D shows the conventional control data.

FIG. 1E shows the initial copy control block.

FIG. 1F is a flowchart of the conventional initial copy.

FIG. 2A shows the principle of the copy control apparatus of the present invention.

FIG. 2B shows the block diagram of the storage apparatus.

FIG. 3 shows the block diagram of the controller.

FIG. 4 shows the control data of the present invention.

FIG. 5 shows the initial copy implementation block.

FIG. 6 is a flowchart of the initial copy of the present invention.

FIG. 7 shows the table of initial copy multiplicity.

FIG. 8 shows the method of providing a program and data.

### DESCRIPTION OF THE PREFERRED EMBODIMENTS

Described below are details of the preferred embodiments of the present invention with reference to the accompanying drawings.

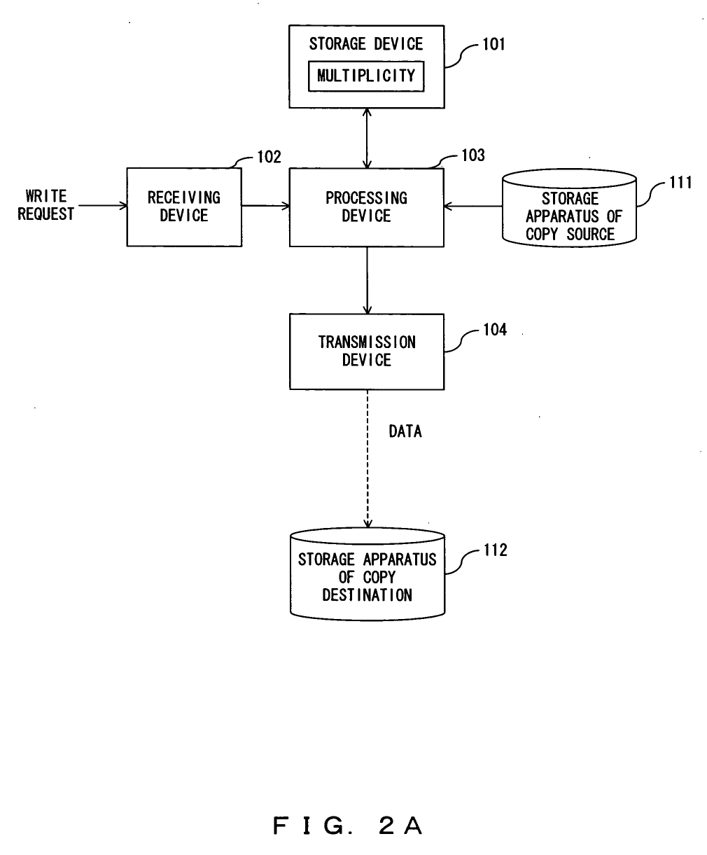

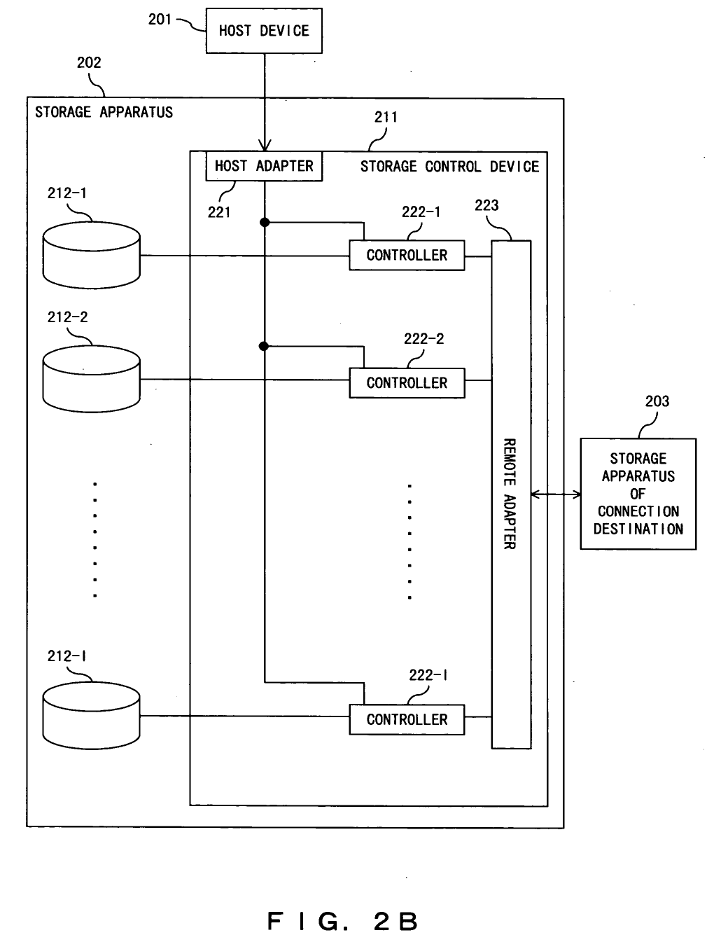

FIG. 2A shows the principle of the first and second copy control apparatuses of the present invention. The copy control apparatus shown in FIG. 2A comprises a storage device 101, a receiving device 102, a processing device 103, and a transmission device 104, and implements an initial copy which copies data of a storage apparatus of a copy source 111 to a storage apparatus of a copy destination 112 and carries out the control of keeping the data of copy source and that of the copy destination equivalent.

The storage device 101 stores the information of multiplicity which indicates the number of initial copies which can be simultaneously implemented, and the receiving device 102 receives write requests to the data of the copy source.

In the first copy control apparatus of the present invention, the processing device 103 implements a plurality of initial copies within a range of multiplicity when the number of write requests in which the updating of the data of copy source is not yet reflected to the data of the copy destination is smaller than a given value, and when the number of write requests is larger than a given value, the processing device 103 changes the multiplicity to a smaller value and implements a plurality of initial copies within the changed range of multiplicity. The transmission device 104 transfers the data of copy source using the storage device 112 of copy destination as the transfer destination when the initial copies are implemented.

When the receiving device 102 does not receive any write request, or when the number of the received write requests is smaller than a given value, the processing device 103 simultaneously implements the initial copies of the number which does not exceed the multiplicity stored in the storage device 101. When the number of the received write requests becomes larger than the given value, the processing device 103 changes the multiplicity to a smaller value and simultaneously implements the initial copies of the number which does not exceed said value.

According to this control, when no write request arises from the host device to the data of the copy source, a maximum number of initial copies are simultaneously implemented. When the write requests of the number which exceeds the given value arise, the number of initial copies which are simultaneously implemented is limited, and the write extension copy which arises in accordance with the write request can be implemented on a preferential basis.

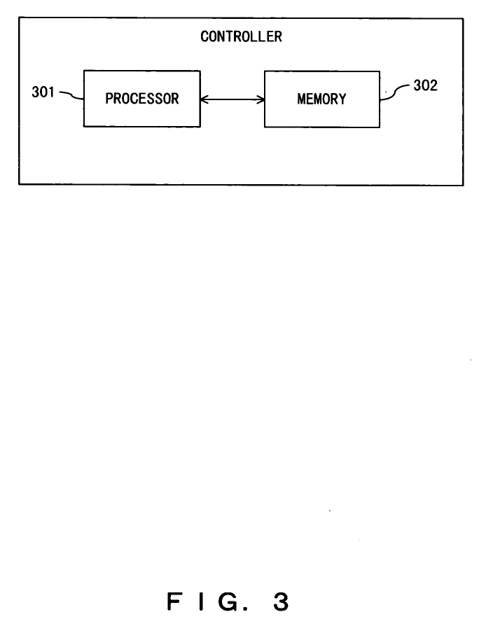

The storage device 101 and the processing device 103 correspond to, for example, a memory 302 and processor 301 shown in FIG. 3, and the receiving device 102 and the transmission device 104 correspond to, for example, a host adapter 221 and remote adapter 223 shown in FIG. 2B. The multiplicity stored in the storage device 101 corresponds to, for example, initial copy multiplicity M described below.

In the second copy control apparatus of the present invention, the processing device 103 decreases multiplicity in accordance with the increase of the number of write requests in which the updating of the data of copy source is not reflected to the data of copy destination, and implements a plurality of initial copies within the decreased range of multiplicity. The transmission device 104 transfers the data of copy source using the storage apparatus 112 of copy destination as the transfer destination when the initial copies are implemented.

According to this control, when no write request to the data of copy source arises, a maximum number of initial copies are simultaneously implemented. The number of initial copies which are simultaneously implemented decreases in accordance with the increase of the number of write requests which arise, and the write extension copy which arises in accordance with the write request can be implemented on a preferential basis.

The third copy control apparatus of the present invention comprises a storage device 101, a first receiving device 102, a processing device 103, a transmission device 104, and a second receiving device and a control device which are not shown in any drawing, and implements initial copies which copy data in the storage apparatus 111 of copy source to the storage apparatus 112 of copy destination, and carries out the control of keeping the data of copy source and that of copy destination equivalent.

The storage device 101 stores the information of multiplicity which indicates the number of initial copies which can be simultaneously implemented, and the first receiving device 102 receives write requests to the data of copy source. The processing device 103 implements a plurality of initial copies within a range of multiplicity when the number of write requests in which the updating of the data of copy source is not yet reflected to the data of copy destination is smaller than a given value, and when the number of write requests is larger than a given value, the processing device 103 changes the multiplicity to a smaller value and implements a plurality of initial copies within the changed range of multiplicity. The transmission device 104 transfers the data of copy source using the storage apparatus 112 of copy destination as the transfer destination when the initial copies are implemented.

The second receiving device receives the data transferred from the transmission device 104, and the control device stores the received data in the storage apparatus 112 of copy destination.

According to this control, when the write requests of the number which exceeds a given value arise, the write extension copy can be implemented on a preferential basis as in the control of the first copy control apparatus.

The second receiving device and the control device correspond to, for example, a remote adapter and controller respectively in the storage apparatus 203 of connection destination shown in FIG. 2B.

According to the present invention, when no write extension copy arises, a larger transfer capability is allocated to an initial copy. The transfer capability allocated to the initial copy decreases in accordance with the increase of the number of write extension copies, and the write extension copy is implemented on a preferential basis. Consequently, both write performance and the initial copy performance can be secured in a good balance.

In this embodiment, in order to manage initial copies, the number of initial copies which can be simultaneously implemented in accordance with each controller in the storage apparatus is determined, and this is defined as initial copy multiplicity. In order to manage write extension copies, a waiting queue for managing the write requests from the host device in the order of its issue is provided.

Each controller supervises the number of the write requests coupled with the waiting queues and changes the initial copy multiplicity in accordance with the number, and implements the initial copies within the determined range of multiplicity. When there is no write request, each controller sets the initial copy multiplicity to a larger value, and implements the initial copies on a preferential basis. When the number of write requests increases, each controller changes the initial copy multiplicity sets to a smaller value and implements write extension copies on a preferential basis. Thus, both the write performance and the initial copy performance can be secured in a good balance.

FIG. 2B shows the configuration of the storage apparatus. The storage apparatus 202 shown in FIG. 2B comprises a storage control device 211 and a plurality of magnetic disk devices 212-1 to 212-I, and the storage control device 211 comprises a host adapter 221, controllers of I (number) 222-1 to 222-I and a remote adapter 223.

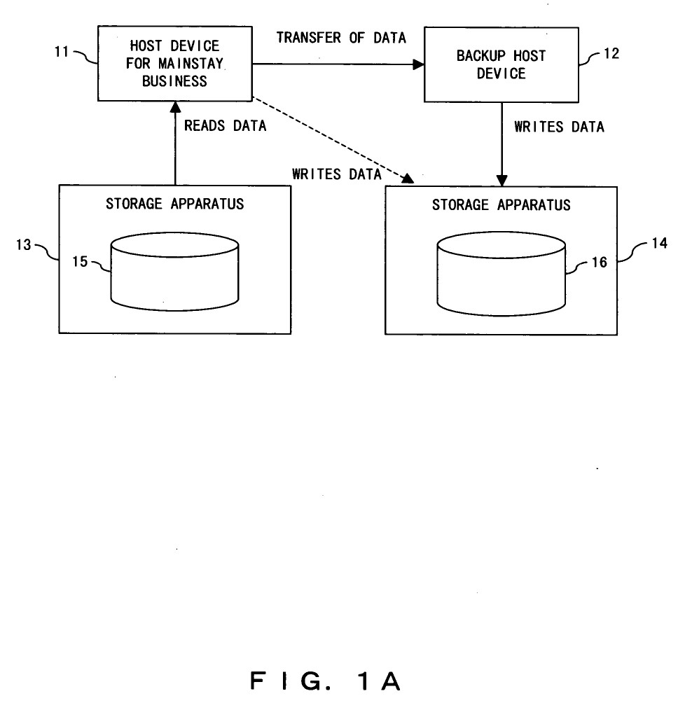

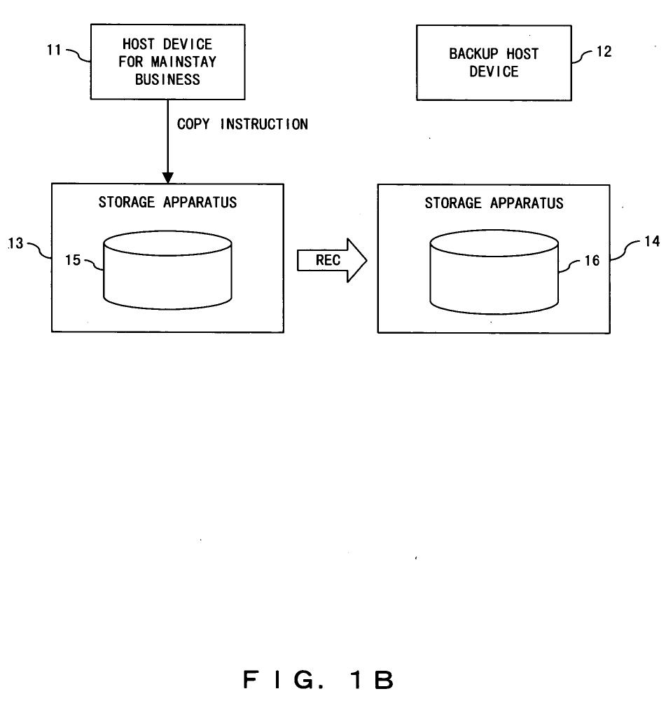

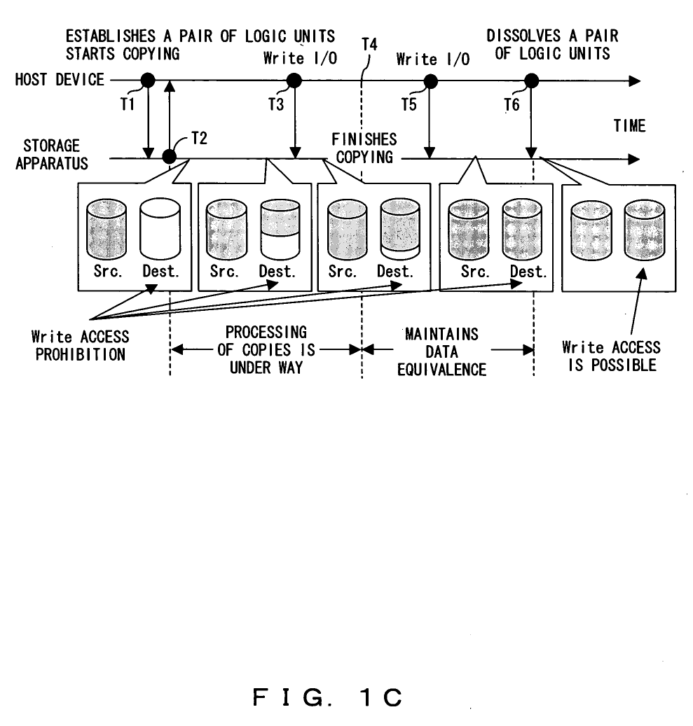

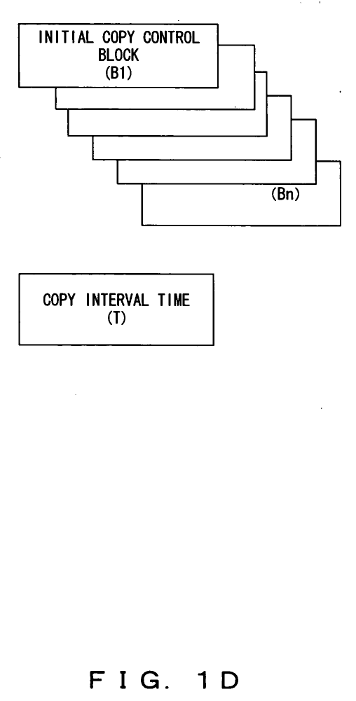

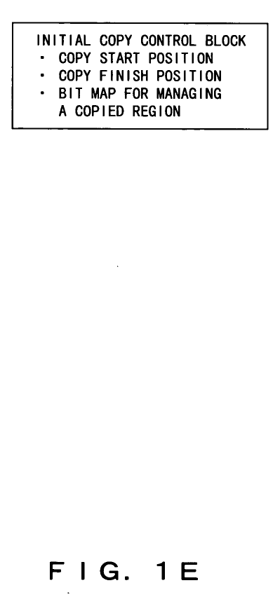

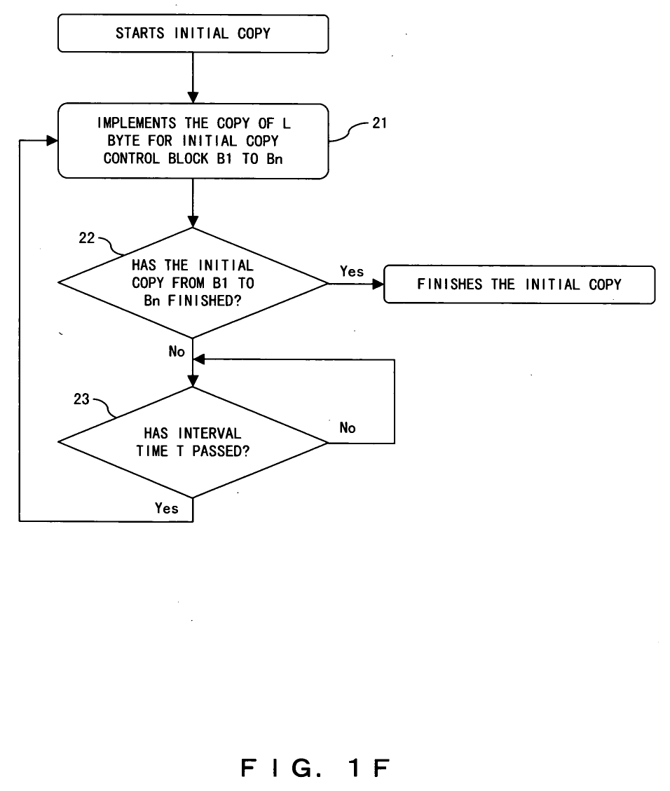

The host device 201 corresponds to the host device for mainstay business 11 shown in FIG. 1B, and issues copy instructions and write requests to each controller 222-i (i=1, 2, . . . , I).

The controller 222-i comprises a processor 301 and a memory 302, as shown in FIG. 3, and controls the access to a magnetic disk device 212-i. The memory 302 stores a program and data which the processor 301 uses, and the processor 301 implements any necessary processing by executing the program using the memory 302. The number of magnetic disks connected to the controller 222-i is not limited to one, but generally, one or a plurality of magnetic disk devices are connected to the controller 222-i.

The host adapter 221 identifies the magnetic disk device which is the object of copy instructions or write requests received from the host device 201, and transfers copy instructions and write requests to the controller which is in charge of controlling the magnetic disk device.

The controller 222-i can communicate with the storage apparatus 203 of connection destination via the remote adapter 223. The remote adapter 223 is connected to the storage apparatus 203 via a communication network, and transfers data between each of the controllers of I (number) 222-1 to 222-I and the storage apparatus 203.

The storage apparatus 203 has the same configuration as that of the storage apparatus 202. When the storage apparatus 202 implements initial copies in accordance with a copy instruction, and the data of the copy source is transferred from the remote adapter 223 to the storage apparatus 203, the remote adapter 223 in the storage apparatus 203 receives the data, and the controller stores the received data in the magnetic disk device of copy destination.

When the storage apparatus 202 implements write extension copies in accordance with write requests and updated data is transferred from the remote adapter 223 to the storage apparatus 203, the remote adapter in the storage apparatus receives the updated data, and the controller overwrites the updated data received on the data of the copy destination in the magnetic disk device.

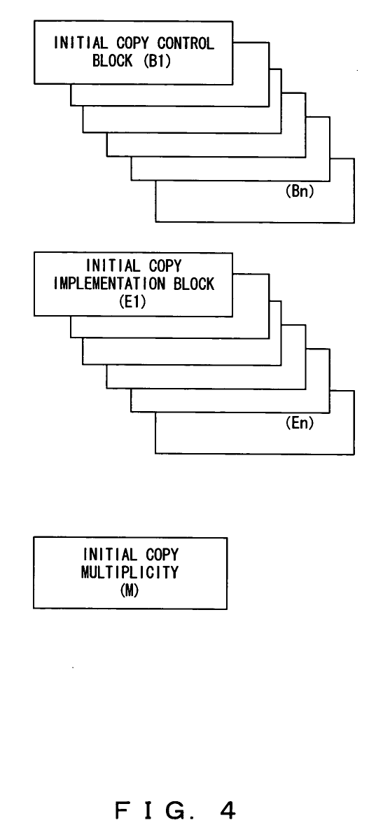

FIG. 4 shows the control data for initial copies which is retained in the memory 302 in each controller 222-i. In this example, the number of copy instructions to the controller 222-i is n, and initial copy control blocks of n B1 to Bn are prepared, while the maximum number of initial copies which are simultaneously implemented in the controller 222-i, and initial copy implementation blocks of m E1 to Em are prepared. Initial copy multiplicity M (M≦m) for each controller is also set.

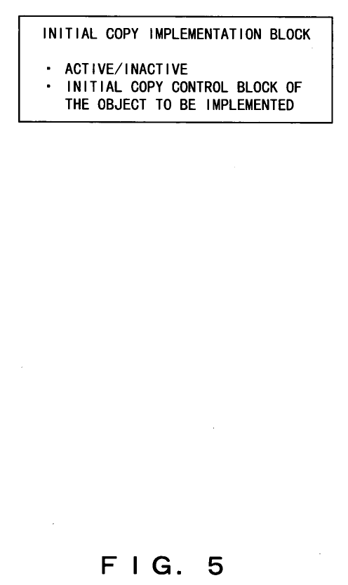

A copy start position, copy end position and bit map for managing a copied region are included in each initial copy control block as is in the case shown in FIG. 1D, and a flag indicating either active or inactive and an identifier indicating initial copy control blocks which are the objects to be implemented are included in each initial copy implementation block, as shown in FIG. 5.

One of the controllers 222-1 to 222-I operates as a master controller, and manages the number of copy instructions to each controller. Stored in the memory 302 of the master controller are the number n of the copy instructions to each controller and the maximum value Mmax of the initial copy multiplicity of the whole storage apparatus. The value of Mmax is calculated in advance by, for example, the following expression using the number I of the controllers mounted and the number J of transfer requests which the remote adapter 223 can simultaneously receive.
Mmax=c×I×J

C is a constant determined by simulation, etc. The master controller distributes the multiplicity Mmax to each controller in accordance with the number n of the copy instructions. As a distribution method, for example, a proportional distribution is used. The value of multiplicity distributed to each controller indicates the maximum value of the initial copy multiplicity M in the controller, and is stored in the memory 302 as the maximum number m.

For example, in the storage apparatus with I=2 and Mmax=15, when the number n of the copy instructions which the controllers 222-1 and 222-2 receive is 16 and 32 respectively, the maximum value m distributed to the controllers 222-1 and 222-2 is 5 and 10 respectively based on a proportional distribution.

The initial copy multiplicity M of each controller indicates the number of initial copies which do not affect the write extension copies, and is determined within the distributed range of maximum value m in accordance with the number of the present write request. The waiting queue, not shown in any drawing, which manages write requests which each controller receives is retained in the memory 302 as the control data for write extension copies.

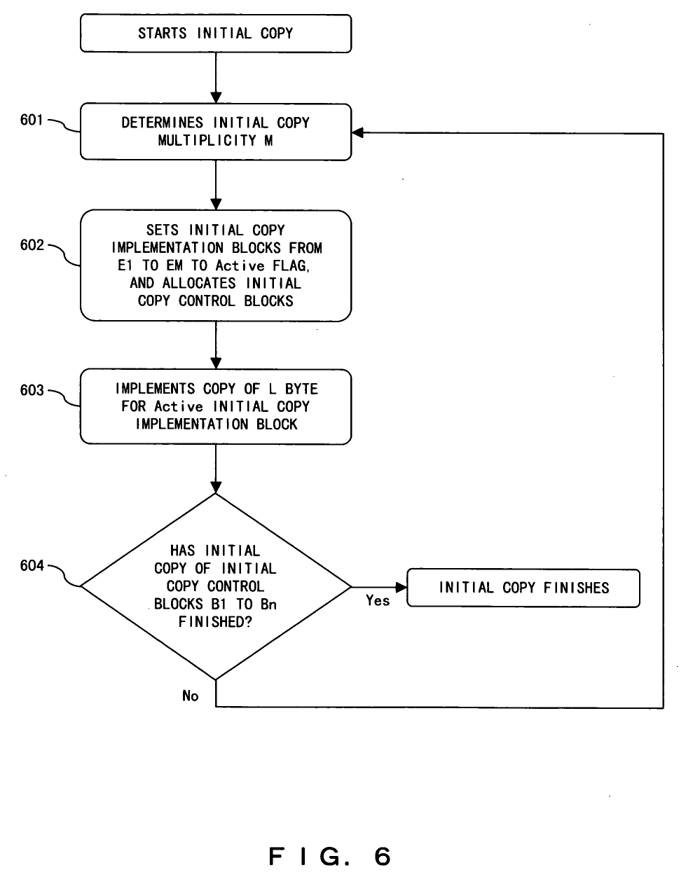

FIG. 6 is a flowchart of the initial copies which the processor 301 in each controller implements when receiving copy instructions. The processor 301 obtains the number of the present write request with reference to the waiting queue of write requests and determines the initial copy multiplicity M within a range of 1 to m in accordance with the number of write request (Step 601). To determine this multiplicity M, for example, one of the following methods is used.

(1) Both designated threshold value TH and large and small multiplicity M1 and M2 (M1>M2) are prepared in the memory 302, and the number of write requests is compared with TH. If the number of write requests is equal to or smaller than TH, larger multiplicity M1 is employed as multiplicity M. If the number of write requests is larger than TH, smaller multiplicity M2 is employed as multiplicity M. Usually, M1 is set to M=M1 as a default value, and when the number of write requests exceeds TH, M1 is changed to M=M2. However, when multiplicity M becomes larger than m, the value of m is employed in place of that value.

(2) An expression for multiplicity M which decreases the multiplicity M in accordance with the increase of the number of write requests are prepared in the memory 303, and the multiplicity M is calculated using the expression. However, when multiplicity M becomes larger than m, the value of m is employed in place of that value.

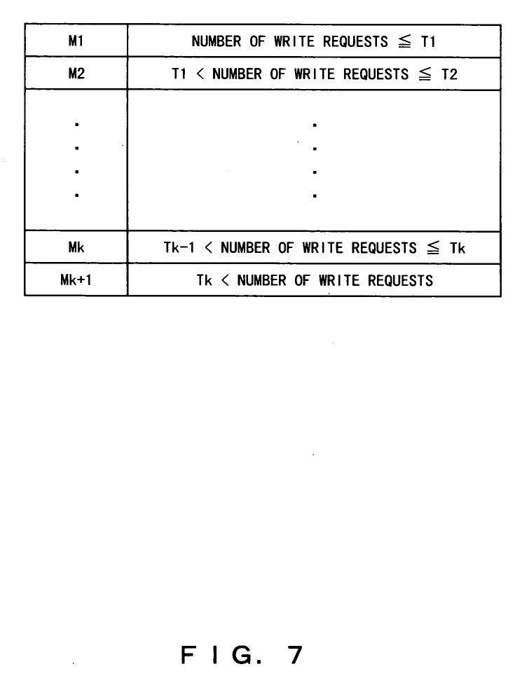

In method (1) described above, a table in which a relationship between the range of the number of write request divided by threshold values of k T1 to Tk (T1<T2< . . . <Tk) and the multiplicity value M1 of k+1 is registered, as shown in FIG. 7, is prepared in the memory 302, and the number of write requests can be made to be compared with each threshold value to select any appropriate multiplicity. In this case, when the obtained multiplicity M is larger than m, the value of m is employed in place of that value.

After multiplicity M is determined in this way, the processor 301 sets the flag of initial copy implementation blocks of m E1 to EM (M≦m) to active, and allocates initial copy control blocks, one by one, to the initial copy implementation blocks (Step 602). Thus, the identifiers of the allocated initial copy control blocks are stored in the initial copy implementation blocks E1 to EM.

Next, the processor 301 implements the copy of the data of L byte for each of the active initial copy implementation blocks (Step 603). In this case, the initial copy implementation blocks having an active flag are referred to, and the initial copy control blocks having the identifiers included in the initial copy implementation blocks are successively referred to. Then, transfer requests of the data which is the object of copy are transmitted to the remote adapter 223 in accordance with the control information stored in the initial copy control blocks, and the data is transferred.

Next, the processor 301 checks whether all the initial copies have finished with reference to the initial copy control blocks B1 to Bn (Step 604). Unless all the initial copies have finished, the processing of Step 601 and onward is repeated, and if all the initial copies have finished in Step 604, the processor 302 terminates the processing.

When the total number of copy instructions changes according to the completion of initial copy and/or the receiving of new copy instructions, the master controller carries out the processing of distributing multiplicity Mmax again.

When the processor 301 receives write requests from the host device 201 within a period in which data equivalence is retained during or after the implementation of initial copies, the processor 301 updates the data of the magnetic disk device which is the object of the write request, and implements write extension copies.

In the processing of write extension copies, the processor 301 refers to the waiting queue of the write requests and checks whether the entries of the write requests are connected to the waiting queue. If the entries of the write requests are connected to the waiting queue, the processor connects the received write requests to the end of the waiting queue, and unless the entries of the write requests are connected to the waiting queue, the processor 301 transmits transfer requests to the remote adapter 223.

If the total number of the present transfer requests has not reached the number J which can receive transfer requests, the remote adapter 223 receives the transfer request transmitted from the controller and implements data transfer. If the total number of the present transfer requests has reached J, the remote adapter 223 rejects the transmitted transfer request. For example, when a lot of transfer requests are transmitted to the remote adapter 223 along with the implementation of initial copies, and if there is no room of the transfer capability, the transmitted transfer requests are not accepted by the remote adapter 223. Unless the transfer requests are accepted, the processor 301 connects the received write requests to the end of the waiting queue.

If the entries of the write requests are connected to the waiting queues, the processor 301 takes out the top entry from the waiting queue and transmits the transfer requests to the remote adapter 223. If the transfer requests are accepted, the processor 301 takes out the next entry and repeats the processing of transmitting the transfer requests. Unless the transfer requests are accepted, the processor 301 connects the taken-out entry to the end of the waiting queues. Thus, data transfer is implemented in order for all entries of the waiting queues.

If the number of write requests of the waiting queues increases, the initial copy multiplicity M decreases accordingly, so the number of active initial copy implementation blocks also decreases. Consequently, transfer requests for initial copies transmitted to the remote adapter 223 decreases, and write extension copies are implemented with priority over the initial copies. Thus, the deterioration of the performance of the storage apparatus 202 which is implementing a remote copy can be stopped.

If the number of write requests of the waiting queues decreases, the initial copy multiplicity M increases accordingly, so the number of active initial copy implementation blocks also increases. Consequently, the transfer capability of the remote adapter 223 can be used all the more for initial copies. In particular, if the number of write requests is 0, the performance of initial copies can be enhanced to its maximum.

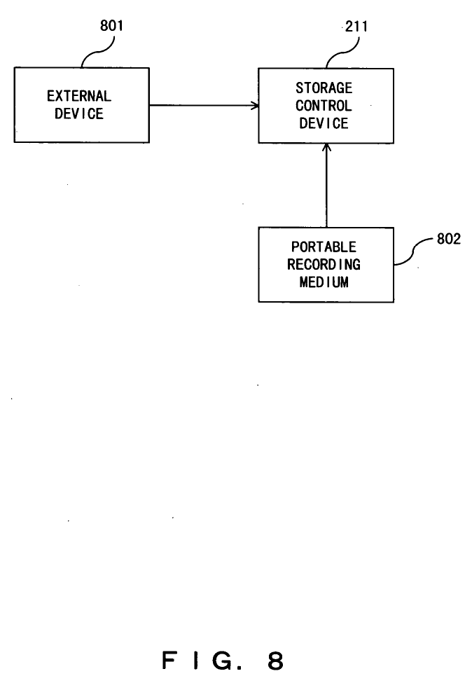

FIG. 8 shows the method of providing a program and data which the processor 301 uses for the processing. The program and data stored in the external device 801 and portable recording medium 802 such as an information processing device are loaded onto the memory 302 of the storage control device 211.

The external device 801 produces a carrier signal which conveys the program and data and transmits the carrier signal to the storage control device 211 via an arbitrary transmission medium on a communication network. The portable recording medium 802 is an arbitrary computer readable recording medium such as a memory card, a flexible disk, an optical disk, a magneto-optic disk or the like. The processor 301 executes the program using the data and implements any necessary processing.

In the storage apparatus shown in FIG. 2B, the magnetic disk device is connected to the storage apparatus, but the present invention can apply to the storage apparatus to which any other storage device such as an optical disk device and a magneto-optic disk device, and any other storage device such as a tape device are connected.

1. A copy control apparatus which implements initial copies which copy the data of a storage apparatus of a copy source to a storage apparatus of a copy destination and carries out the control of keeping the data of the copy source and that of the copy destination equivalent, comprising:
a storage device storing the information of multiplicity which indicates the number of initial copies which can be simultaneously implemented;
a receiving device receiving write requests for the data of the copy source;
a processing device implementing a plurality of initial copies within a range of multiplicity specified below when the number of write requests in which the updating of the data of copy source is not yet reflected to the data of copy destination is smaller than a given value, and changing the multiplicity to a smaller value when the number of write requests is larger than a given value, and implementing a plurality of initial copies within the changed range of multiplicity; and
a transmission device transferring the data of copy source using the storage apparatus of copy destination as the transfer destination when the initial copies are implemented.

2. The copy control apparatus according to claim 1, wherein
said storage device stores waiting queues which manage write requests; and
said processing device refers to the entries of write requests connected to the waiting queues and obtains the number of write requests.

3. The copy control apparatus according to claim 1, wherein
said receiving device receives copy instructions for the data of copy source;
said storage device stores the initial copy control information of n which includes the control information designating the data of copy source using the number of copy instructions received as n and stores multiplicity M as the information of the multiplicity; and
said processing device selects the initial copy control information of M out of n and simultaneously implements initial copies of M.

4. The copy control apparatus according to claim 3, wherein
said storage device stores the initial copy implementation information of m which includes respective flags;
said processing device sets the flag of the initial copy implementation information of M out of m to an active flag, sets the identifier indicating a piece of initial copy control information for the initial copy implementation information of M, selects the initial copy control information which the identifier of the initial copy implementation information having an active flag indicates, and simultaneously implements initial copies of M.

5. A copy control apparatus which implements initial copies which copy the data of the storage apparatus of a copy source to a storage device of a copy destination and carries out the control of keeping the data of the copy source and that of the copy destination equivalent, comprising:
a storage device storing the information of multiplicity which indicates the number of initial copies which can be simultaneously implemented;
a receiving device receiving write requests for the data of the copy source;
a processing device decreasing the multiplicity in accordance with the increase of the number of write requests in which the updating of the data of the copy source is not yet reflected to the data of the copy destination, and implementing a plurality of initial copies within the changed range of multiplicity; and
a transmission device transferring the data of copy source using the storage apparatus of copy destination as the transfer destination when the initial copies are implemented.

6. The copy control apparatus according to claim 5, wherein
said storage device stores waiting queues which manage write requests; and
said processing device refers to the entries of write requests connected to the waiting queues and obtains the number of write requests.

7. The copy control apparatus according to claim 5, wherein
said receiving device receives copy instructions for the data of copy source;
said storage device stores the initial copy control information of n which includes the control information designating the data of copy source using the number of copy instructions received as n and stores multiplicity M as the information of the multiplicity; and
said processing device selects the initial copy control information of M out of n and simultaneously implements initial copies of M.

8. The copy control apparatus according to claim 7, wherein
said storage device stores the initial copy implementation information of m which includes respective flags;
said processing device sets the flag of the initial copy implementation information of M out of m to an active flag, sets the identifier indicating a piece of initial copy control information for the initial copy implementation information of M, selects the initial copy control information which the identifier of the initial copy implementation information having an active flag indicates, and simultaneously implements initial copies of M.

9. A storage apparatus which implements initial copies which copy data of a copy source to a storage apparatus of a copy destination and carries out the control of keeping the data of copy source and that of copy destination equivalent, comprising:
a storage apparatus storing data of copy source;
a storage device storing the information of multiplicity indicating the number of initial copies which can be simultaneously implemented;
a receiving device receiving write requests for the data of the copy source;
a processing device implementing a plurality of initial copies within a range of multiplicity specified below when the number of write requests in which the updating of the data of copy source is not yet reflected to the data of the copy destination is smaller than a given value, and changing the multiplicity to a smaller value when the number of write requests is larger than a given value, and implementing a plurality of initial copies within the changed range of multiplicity; and
a transmission device transferring the data of the copy source using the storage apparatus of the copy destination as the transfer destination when the initial copies are implemented.

10. A copy control apparatus which implements initial copies which copy the data of a storage apparatus of a copy source to a storage apparatus of a copy destination and carries out the control of keeping the data of the copy source and that of the copy destination equivalent, comprising:
a storage device storing the information of multiplicity indicating the number of initial copies which can be simultaneously implemented;
a first receiving device receiving write requests for the data of the copy source;
a processing device implementing a plurality of initial copies within a range of multiplicity specified below when the number of write requests in which the updating of the data of copy source is not yet reflected to the data of the copy destination is smaller than a given value, and changing the multiplicity to a smaller value when the number of write requests is larger than a given value, and implementing a plurality of initial copies within the changed range of multiplicity; and
a transmission device transferring data of the copy source using the storage apparatus of the copy destination as the transfer destination when the initial copies are implemented;
a second receiving device receiving the data transferred from the transmission device; and
a control device storing the received data in the storage apparatus of the copy destination.

11. A storage system which implements initial copies which copy the data of a copy source to the data of a copy destination and carries out the control of keeping the data of the copy source and that of the copy destination equivalent, comprising:
a storage apparatus storing the data of the copy source;
a storage apparatus of the copy destination;
a storage device storing the information of multiplicity which indicates the number of initial copies which can be simultaneously implemented;
a first receiving device receiving write requests for the data of the copy source;
a processing device implementing a plurality of initial copies within a range of multiplicity specified below when the number of write requests in which the updating of the data of the copy source is not yet reflected to the data of the copy destination is smaller than a given value, and changing the multiplicity to a smaller value when the number of write requests is larger than a given value, and implementing a plurality of initial copies within the changed range of multiplicity; and
a transmission device transferring the data of the copy source using the storage apparatus of the copy destination as the transfer destination when the initial copies are implemented;
a second receiving device receiving the data transferred from the transmission device; and
a control device storing the received data in the storage apparatus of the copy destination.

12. A recording medium recording a program for the processor which implements initial copies which copy the data of a storage apparatus of a copy source to a storage device of a copy destination and carries out the control of keeping the data of the copy source and that of the copy destination equivalent, wherein the program directs the processor to perform the processes of:
comparing the number of write requests in which the updating of the data of the copy source is not yet reflected to the data of the copy destination with the given value stored in a storage device; and
implementing a plurality of initial copies within a range of multiplicity indicating the number of initial copies which can be simultaneously implemented when the number of write requests is smaller than a given value, and changing the multiplicity to a smaller value when the number of write requests is larger than the given value, and implementing a plurality of initial copies within the changed range of multiplicity.

13. A carrier signal conveying a program for the processor which implements initial copies which copy the data of a storage apparatus of a copy source to a storage apparatus of a copy destination and carries out the control of keeping the data of copy source and that of copy destination equivalent, wherein the program directs the processor to perform the processes of:
comparing the number of write requests in which the updating of the data of the copy source is not yet reflected to the data of the copy destination with a given value stored in a storage device; and
implementing a plurality of initial copies within a range of multiplicity indicating the number of initial copies which can be simultaneously implemented when the number of write requests is smaller than a given value, and changing the multiplicity to a smaller value when the number of write requests is larger than the given value, and implementing a plurality of initial copies within the changed range of multiplicity.

14. A copy control method which implements initial copies which copy the data of a storage apparatus of a copy source to a storage apparatus of a copy destination and carries out the control of keeping the data of copy source and that of copy destination equivalent, wherein
a processing device compares the number of write requests in which the updating of the data of copy source is not yet reflected to the data of the copy destination with a given value stored in a storage device; and
the processing device implements a plurality of initial copies within a range of multiplicity indicating the number of initial copies which can be simultaneously implemented when the number of write requests is smaller than a given value, and changes the multiplicity to a smaller value when the number of write requests is larger than the given value, and implements a plurality of initial copies within the changed range of multiplicity.

15. A copy control apparatus which implements initial copies which copy the data of a storage apparatus of a copy source to a storage apparatus of a copy destination and carries out the control of keeping the data of the copy source and that of the copy destination equivalent, comprising:
storage means for storing the information of multiplicity which indicates the number of initial copies which can be simultaneously implemented;
receiving means for receiving the write request for the data of the copy source;
processing means for implementing a plurality of initial copies within a range of multiplicity specified below when the number of the write requests in which the updating of the data of copy source is not yet reflected to the data of the copy destination is smaller than a given value, and for changing the multiplicity to a smaller value when the number of write requests is larger than a given value, and for implementing a plurality of initial copies within the changed range of multiplicity; and
transmission means for transferring the data of copy source using the storage apparatus of copy destination as the transfer destination when the initial copies are implemented.

16. A copy control apparatus which implements initial copies which copy the data of a storage apparatus of a copy source to a storage apparatus of a copy destination and carries out the control of keeping the data of the copy source and that of the copy destination equivalent, comprising:
storage means for storing the information of multiplicity which indicates the number of initial copies which can be simultaneously implemented;
receiving means for receiving write requests for the data of the copy source;
processing means for decreasing the multiplicity in accordance with the increase of the number of write requests in which the updating of the data of the copy source is not yet reflected to the data of the copy destination, and for implementing a plurality of initial copies within the changed range of multiplicity; and
transmission means for transferring the data of the copy source using the storage device of the copy destination as the transfer destination when the initial copies are implemented.
